(19) United States
(12) Patent Application Publication
(10) Pub. No.: US 2017/0022008 A1
(43) Pub. Date: Jan. 26, 2017

(54) CONTAINER COMPACTION

(71) Applicant: Envac AB, Stockholm (SE)

(72) Inventor: Jonas TÖRNBLOM, Stockholm (SE)

(73) Assignee: Envac AB, Stockholm (SE)

(21) Appl. No.: 15/104,148

(22) PCT Filed: Dec. 20, 2013
(86) PCT No.: PCT/EP2013/077717

§ 371 Date: Jun. 13, 2016

(51) Int. Cl. B65F 5/00; B65F 1/14

(52) U.S. Cl. CPC B65F 5/005; B65F 1/1473; B65F 1/141; B65F 2210/148

(57) ABSTRACT

In a method of compacting waste (W), wherein waste is introduced into a generally box shaped elongated waste container (3) through at least one waste inlet (5) thereof and is collected in the waste container (3) at a waste collection station (4), the container is positioned with a generally rectangular bottom wall (3 A) thereof on an inclined surface (7) of the waste collection station, thereby tilting the container and its bottom wall, and releasably securing the container in the tilted position. A waste collection facility (13) of the waste collection station (4) is also provided.

### TECHNICAL FIELD

The disclosure generally concerns the management of waste and specifically relates to a method and a facility for compacting waste introduced into a waste container.

### BACKGROUND

A common and recent desire in the field of waste collection and transport systems is to minimize space requirements and energy consumption for waste management and transport. This is a general fact of all waste management but is emphasized in vacuum operated waste collection systems. In vacuum systems large transport pipe dimensions would lead not only to greater space requirements within buildings and lager excavations but also to unacceptable energy consumption for waste transport. The temporary waste storage at waste inlet locations as well as the eventual central waste storage in waste collection stations likewise tends to be a bottleneck in today's system that will have to cope with larger and larger amounts of waste.

In recent years increasingly sophisticated control system have been developed to optimize waste management times in order to partially eliminate the waste volume issues. However, such waste management control can only partially solve the volume issues. It has therefore been common to combine such control systems with a conventional and very effective way of managing some of the waste volume issues by providing waste compaction equipment at various locations in the systems. Examples thereof are compaction of waste in special waste compactors or compaction in inlet chutes as well as just upstream of and in storage volumes by means of various types of e.g. hydraulic rams as in US2013319264A1 or compaction screws as in WO2012035308A3. All such solutions include rather expensive constructions and also require considerable space by themselves.

Prior art solutions have thus not provided any optimum solution to the waste volume issues, and especially not any solution that is both effective and advantageous from a space requirement point of view and economical.

### SUMMARY

It is a general object to provide a solution to the above discussed problems.

In particular it is an object of the disclosure to suggest a method of providing improved waste management and waste compaction in a waste container.

It is another object of the disclosure to suggest an improved waste collection facility.

These and other objects are met by the invention as defined by the accompanying claims.

The invention generally relates to a method of compacting and managing waste wherein waste is introduced into a generally box shaped elongated waste container through at least one waste inlet thereof and is collected in the waste container at a waste collection station. In a basic configuration the method includes positioning the container with a generally rectangular bottom wall thereof on an inclined surface of the waste collection station, thereby tilting the container and its bottom wall relative to a base surface. The container is releasably and securely held in the tilted position.

In accordance with a further aspect of the invention a waste collection facility of a waste collection station is suggested. The facility includes a generally box shaped elongated waste container having at least one waste inlet for the introduction and collection of waste in the waste container. In a basic configuration the facility comprises a ramp-like container support having an inclined container support surface and cooperating connectable and releasable locking means provided to lock in position a tilted container being supported on the ramp-like container support and to release said container for removal, respectively.

Preferred further developments of the basic inventive idea as well as embodiments thereof are specified in the dependent subclaims.

Advantages offered by the present technology, in addition to those described above, will be readily appreciated upon reading the below detailed description of embodiments thereof.

### BRIEF DESCRIPTION OF THE DRAWINGS

The invention and its further objects and advantages will be best understood by reference to the following description taken together with the accompanying drawings, in which:

FIG. 1 is a schematical and partial side view of an embodiment of a waste collection facility of a waste collection station;

FIG. 2 is a side view of the embodiment of FIG. 1 illustrating a first phase of positioning an empty waste container in a collection station;

FIG. 3 is a view like the one in FIG. 2 illustrating parts of the waste collection facility in greater detail;

FIGS. 4-5 are likewise partial and schematical illustrations of a container in loading position in a collection station and of removing a loaded waste container from a collection station, respectively.

### DETAILED DESCRIPTION

The present technology will be explained with reference to exemplifying embodiments thereof and specifically with reference to a method of compacting and managing waste and to a waste collection facility of a waste collection station. These embodiments relate to an application of this technology to a vacuum operated waste collection system. It is emphasized that the illustrations are for the sole purpose of describing preferred embodiments of the proposed technology and are not intended to limit the technology to details or to any specific field of application thereof. This technology may be applied generally in the field of waste collection and waste management and to systems of well known configuration and thus the systems as such are not disclosed in any detail. The described technology is with appropriate modifications equally well suited for application to other types of environments and for other types of waste transport and collection than those specifically disclosed. It shall thus be realized that this disclosure covers the incorporation of features related to other applications and any combination of features disclosed herein.

As discussed above, previous solutions for managing waste volume issues as well as associated storage location space requirements have all been only partially successful and mostly too expensive to become generally accepted. The present technology attempts to find an effective and versatile solution to the problems of handling increasing waste volumes especially at centrally located waste collection stations. This is done by taking a new approach for combining effective compaction and uncomplicated configuration and thus low costs. The object is to provide an effective, fairly simple and thereby economical solution that will also contribute to a reduced space requirement at central collection stations of waste collection systems. Containers of a type having designated separators and/or connected compactor equipment are presently being phased out and this will cause the waste holding capacity at collection stations to be reduced. Thus, a way of compensating for this capacity reduction needs to be found, other than by simply adding more containers.

The solution of this disclosure will allow for the use of modified conventional container and container haulage equipment, such as haulage trucks with conventional hook-lift equipment. It may be applied to many types, shapes and sizes of containers by making appropriate adjustments and modifications and will contribute to reducing the size of collection stations. This is accomplished by means of waste compacting and managing methods and associated facilities that will allow for cost and space effective waste volume management. Specifically, the suggested solution involves providing a sort of self-compaction of waste in a container. With the suggested technology this is basically achieved by raising the container inlet side. By taking advantage of natural forces, namely gravity and waste weight, it is possible for a standard container to take in more waste provided that the container is inclined-tilted.

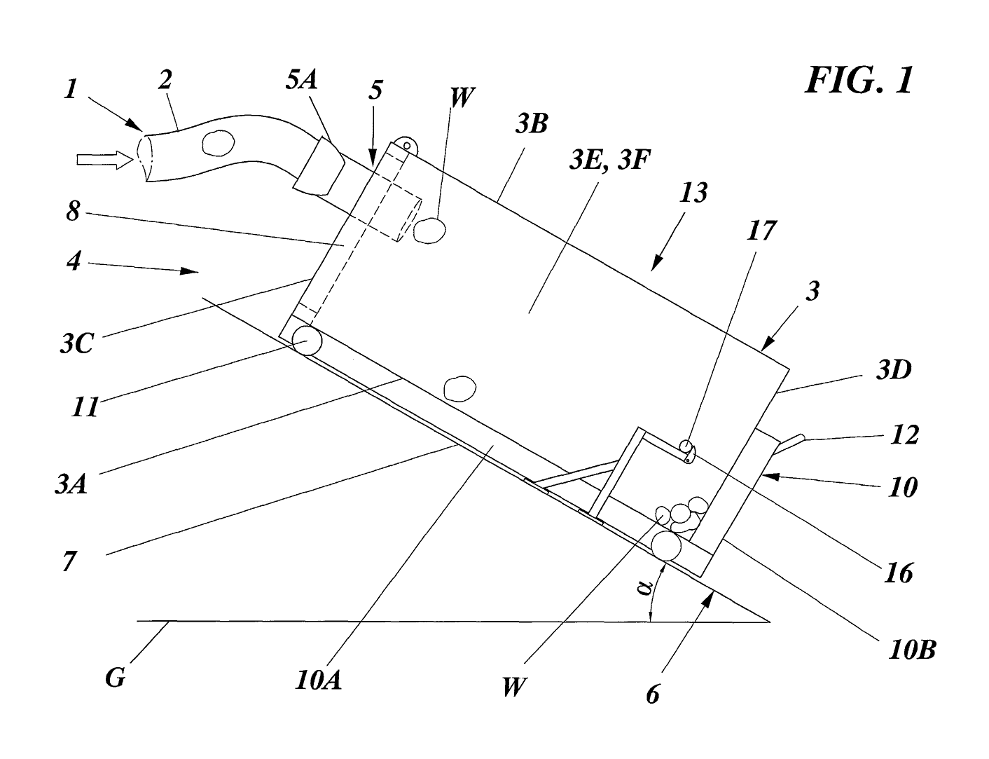

The present technology will be explained below with reference to an exemplifying, partly schematical embodiment thereof that is illustrated in the accompanying drawing figures. In FIGS. 1-5 is outlined an embodiment of a waste management facility configured in accordance with the presently proposed technology. Specifically, in FIG. 1 is shown a very schematic view of an exemplary facility 13 for use in any type of conventional pneumatic waste collection and transport system 1 that is not illustrated in detail but is only indicated by the outlined waste transport pipe 2.

The waste collection facility 13 is part of a waste collection station 4 that in the illustrated embodiment serves to receive waste W having been transported thereto by vacuum, from various waste inlet locations and through waste transport pipes 2. The waste collection station 4 includes a generally box shaped elongated and/or rectangular waste container 3 of a generally conventional type having at least one waste inlet 5 for the introduction and collection of waste in the waste container 3. In the collection station is provided one or more ramp-like container supports 6 each having an inclined container support surface 7 on which an empty container 3 is placed in a manner that will be described further below. The container 3 consists of preferably generally rectangular bottom and top walls 3A, 3B, respectively, and front and rear, preferably generally rectangular end walls 3C and 3D, respectively. The waste inlet 5 is positioned in an upper region of the front container end wall 3C that may normally be supplemented on its inner side by a filter 8 schematically indicated in FIG. 1. Cooperating connectable and releasable locking means 16, 17 are provided by the container 3/container support 6 to lock in position a tilted container being supported on the ramp-like container support 6 and to release said container 3 for removal, respectively. In this particular, disclosed embodiment said locking means comprise a lock bolt 17 that is attached to each of two, likewise generally rectangular, container side walls 3E, 3F (only one visible in the drawings) for locking cooperation with a designated releasable latch 16. The cooperating lock bolt 17 and latch 16 combination will keep the container 3 in position on the inclined container support surface 7 without sliding down during container loading. Such a combination presents one easy way of locking a container 3 in position by using the self-locking latch 16 with free movement backwards and spring-loaded swing-back to “catch” the lock bolt 17.

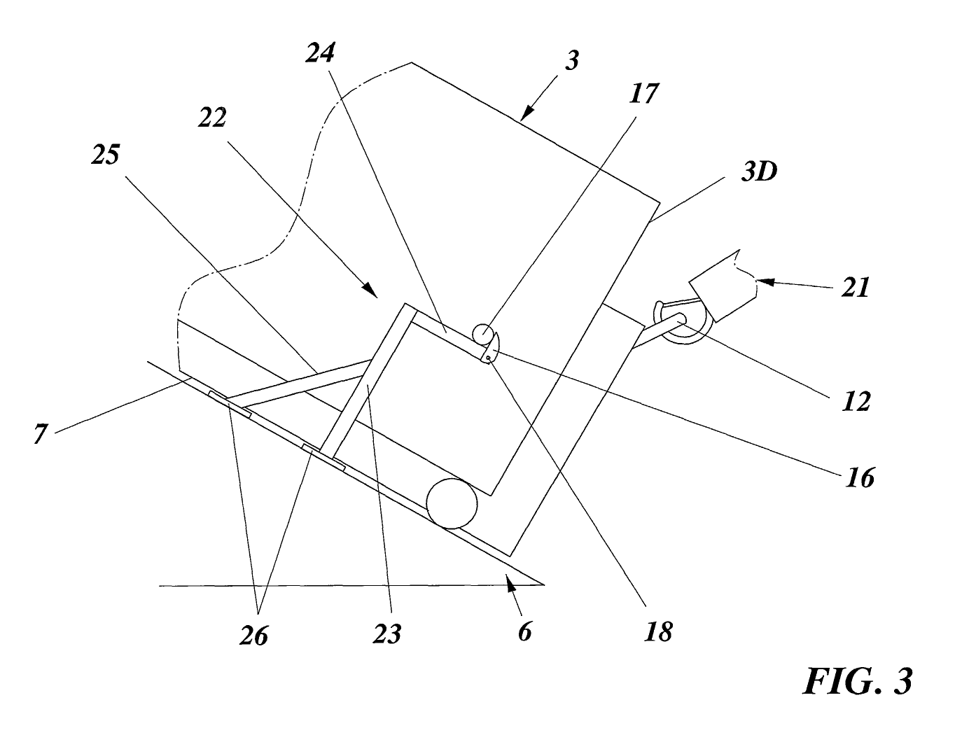

One such releasable latch 16 is provided adjacent to each side of the ramp-like container support 6 for cooperation with the corresponding lock bolt 17 of the container 3 side walls 3E, 3F to lock in position a tilted container being supported on the ramp-like container support 6. In FIG. 3 is illustrated one of two latch frames 22 for securing the latches 16 to the container support 6 and each consisting basically of foot plates 26 secured to the container support 6 and interconnected support beams 23-25 carrying and positioning the latches 16.

It should now be realized that the tilted position of the container 3 on the inclined container support surface 7 of the ramp-like container support 6 will cause waste W introduced into the container through the waste inlet 5 to be compacted as it falls down in the lower rear corner of the rear end wall 3D. The inclined container support surface 7 of the ramp-like container support 6 is inclined at an angle α. An appropriate tilting of the container 3 for such compaction purpose will be in the order of 20-90°, preferably approximately 30°, relative to a ground surface G. Such an inclination will cause not only compaction by the actual fall but also by the weight of subsequently introduced waste W. The optimal angle of tilt will preferably be chosen for each application based on the considerations that too little tilt will not achieve good “gravity drop and compaction” in the container and that too much tilt will cause the container front end 3C to be raised too much to be practical.

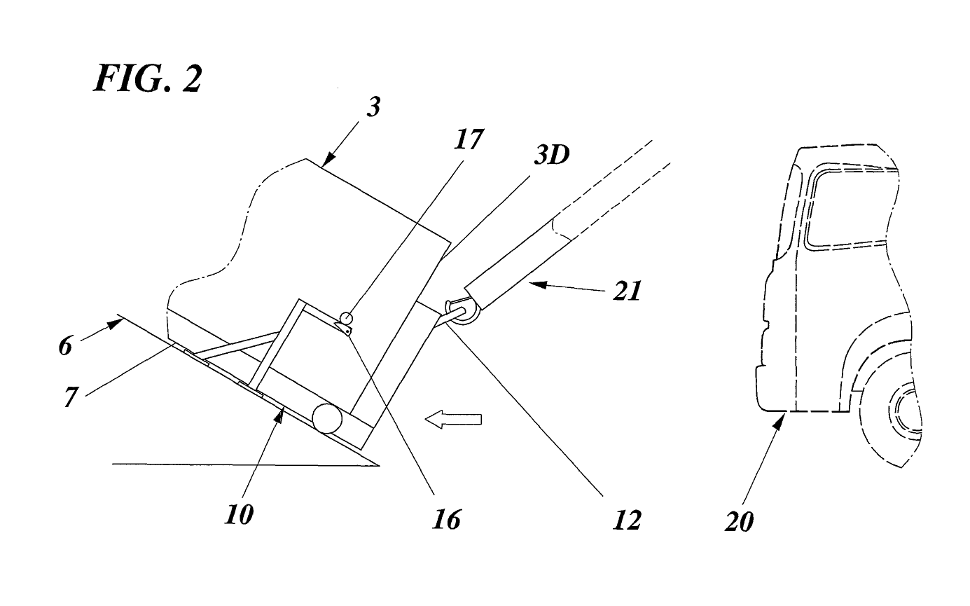

For the positioning and overall handling of the container 3 a container handling frame 10 is secured to the container 3 with a bottom part 10A thereof extending along a major portion of the container bottom wall 3A. A towing-type eyelet 12 is secured to an upright part 10B of the handling frame 10 extending at least partially along the rear container end wall 3D. The towing eyelet 12 may be used for pushing up a container 3 along the inclined container support surface 7 of the ramp-like container support 6 by using a container shifting haulage truck 20 (FIG. 2) when positioning an empty container in a loading position as shown in FIG. 1. The same haulage truck 20 may then be used to at least initiate or promote sliding of the container 3 down the inclined surface 7 by pulling and lifting said towing-type eyelet 12 with the truck and its hook-lift equipment 21 used for switching containers 3. During such container shift the truck 20 hook-lift equipment 21 pulls and slightly lifts the container so that it will naturally swing slightly “upwards” with the rear end wall 3D, thus unlocking the lock bolt/latch combination. Simple support wheels 11 are preferably provided on the bottom part 10A of the container handling frame 10 for facilitating sliding of the container 3 up as well as down the inclined container support surface 7 of the ramp-like container support 6.

It is preferred to release and pull out a container 3 without driver intervention and the above mentioned lifting action will disengage each lock-bolt 17 from the associated latch 16 that is preferably spring-loaded to the upright position, blocking downhill movement of a positioned container 3. In particular, the latch 16 is rotatably supported on a pivot pin 18 for rotation in one direction against a preloading spring action, allowing its free passage past the lock bolt 17 as the container 3 is pushed upwardly on the inclined container support surface 7 (see especially FIG. 2). It will be understood then that it is blocked from rotation in an opposite direction past the upright position of FIGS. 1 and 3, thereby locking the container 3 in its tilted loading position on the inclined container support surface 7.

A preferred further development is to provide a waste inlet 5 that is equipped with a curved docking cone 5A instead of the conventional straight cone. The same consideration applies to the docking of an exhaust air outlet pipe (not specifically shown) in the vacuum operated system 1. This will allow secure docking with a waste collection system 1 waste transport pipe 2 and air outlet, respectively, without risking any damage to the docking cone or other docking components during container 3 shift. Further security against docking damage may be achieved by means of increased clearance tolerance of the docking components.

With the proposed solution a cost effective and space compact collection station waste compaction is achieved without any separators along with their connected equipment, such as hydraulic pumps, and without compactors. The installation in the collection station is significantly simplified with static equipment limited to diverters and pipework and with an exhauster room unchanged. Simpler installation means generally lower costs. In most cases cost of operation is expected to be reduced since the solution is basically applied to a simpler prior art system.

It will be understood that the present technology likewise concerns a method of compacting and managing waste W wherein waste is introduced into the generally box-shaped waste container 3 through the at least one waste inlet 5 thereof and is collected in the waste container 3 at a waste collection station 4. When entering an empty container 3 into the waste collection station 4 the container is positioned with a generally rectangular bottom wall 3A thereof on an inclined surface 7 of the waste collection station, thereby tilting the container 3 and its bottom wall 3A.

As is indicated especially in FIG. 2 this empty container 3 installation is preferably performed by pushing the container up along and into a waste loading position on the inclined surface 7 such as by means of a haulage truck 20 used for switching containers and by using its hook-lift equipment 21. As a container 3 is pushed in/up the latch 16 is folded down to the left in FIG. 2 until the container has arrived in the correct loading position as depicted in FIGS. 1 and 3. With a correctly positioned container 3 the latch 16 springs back and retains the container 3 in such loading position. After installation the container 3 is releasably and securely held in the tilted loading position in the manner described above. Such installation of the container 3 in the tilted loading position will position the waste inlet 5 at the front end wall 3C of the waste container 3, adjacent a top wall 3B thereof, so that it is elevated above a ground surface G or similar. During such installation a container waste inlet 5, as well as possibly an air evacuation outlet, is docked with a waste transport pipe 2 and an air outlet pipe, respectively, of a waste collection system 1.

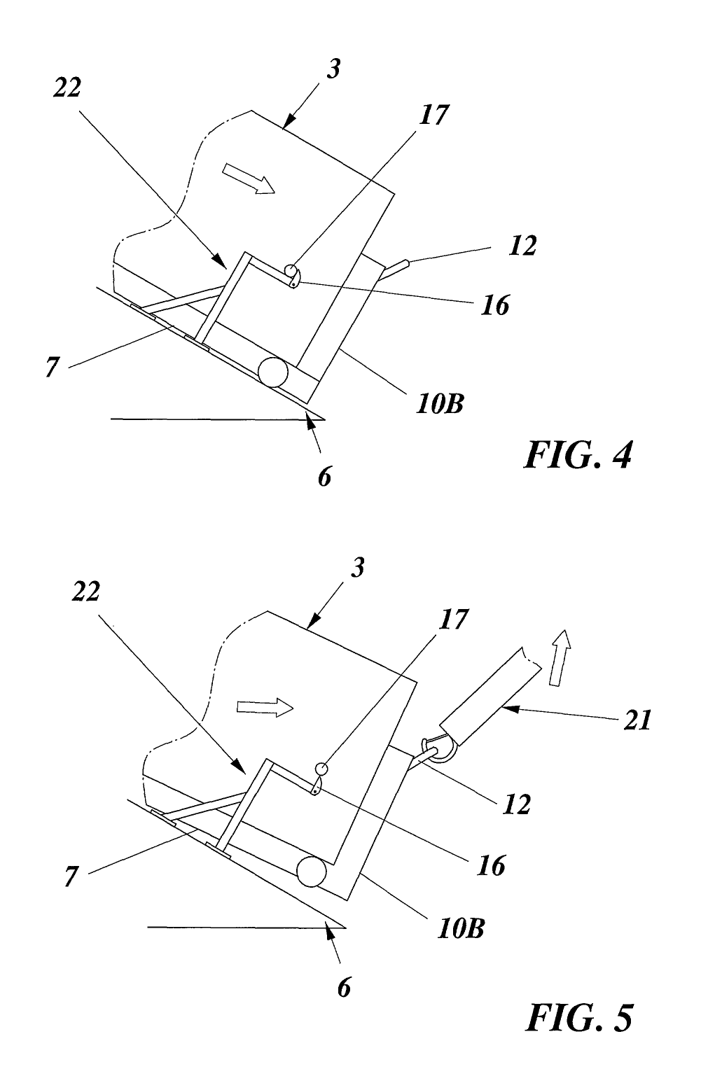

Secure installation and removal of the container 3 is established by providing a container handling frame 10 and by extending said container handling frame along a major portion of the container bottom wall 3A and at least partially along a rear container end wall 3D. When removing a loaded tilted container 3 for haulage and emptying it will be caused to slide down the inclined surface 7, whereby such sliding is preferably facilitated by the provision of support wheels 11 on a bottom part 10A of the handling frame 10. Initiating sliding of the container 3 down the inclined surface 7 for switching containers is performed by lifting and pulling (see FIG. 4), preferably by means of the haulage truck 20 hook-lift 21. Such hook-lift equipment is normally used for switching containers 3, and is connected to a towing-type eyelet 12 provided on an upright part 10B of the handling frame 10 that is extended at least partially along the rear container end wall 3D. Removal of a loaded container 3 from the inclined surface 7 may thus be initiated by connecting a haulage truck 20 to the container 3 that with the described locking system is then lifted approximately 10 cm to unhook the lock bolt 17 from the latch 16. Then the container 3 is pulled or slid down and then finally lifted onto the haulage truck 20. Lifting a lower, rear end wall 3D of the container 3 by the towing-type eyelet 12 thus releases the container 3 from the secure holding thereof by the engagement of the combination of a cooperating lock bolt 17 secured to the corresponding container side wall 3E, 3F and a releasable latch 16 provided adjacent each container side wall 3E, 3F. This locking configuration and its function was described in detail above. Performing container shift by means of hook-lift truck 20 may cause a fully loaded container to apply to much vertical down load on a hook-lifter but this may be coped with by lifting up the container 3 only once it has moved down half the slope of the inclined container support surface 7.

It has been indicated above that it is preferable to be able to perform a container shift, push-in and pull-out, easily without operator intervention. As the container is pushed in the latches 16 will be swung down in the anticlockwise direction in FIG. 2 by the contact with the respective lock bolts 17, until returning to the upright position of FIGS. 1, 3 and 4 when the container has been properly positioned. In this embodiment, a simple container ‘hook-catch” design has been configured that uses the natural truck “container pulling/container lift” tendency to unlock the container naturally as the driver pulls out the container from its tilted position, see FIG. 5. As indicated above this locking will work without any supplied external force but it may be powered for specific applications.

The basic configurations of the facility and method may present several advantages such as:
Compaction by gravity is estimated to double the capacity of a container compared to a regular container without compaction;
Increasing the container angle of tilt will increase the force created by gravity thereby allowing control of the degree of compaction and thus of the container capacity;
The self-compaction of container waste material provides for an increased local storage capacity and/or a reduced size of a collection station;
The container can be filled to a practical maximum (towards 100% of the volume), whereas normally the upper corners at both sides of the container will not be filled.
The smaller collection station also leads to reduced overall costs relating to less equipment, lower installation costs and lower civil works costs;
Larger waste capacity means less container shifting and haulage;
The capacity may be further increased when combined with waste compaction at waste inlet locations so that the tilted container is supplied with pre-compacted waste from such inlet locations.

In alternative, but not specifically illustrated embodiments variations of different parts of the method and facility configurations may be employed without departing from the scope of the technology. An example of this is the use of other ways of raising the container inlet end than by means of the disclosed ramp-like container support. Other feasible ways of obtaining the same or similar result is to employ a crane or a lift table etc. In such cases alternative embodiments of the container locking means provided for locking in position a tilted container being supported on the ramp-like container support may be employed. One example thereof would be to use at least one fixed stop provided on the inclined surface of the container support and cooperating with the lower edge of the rear container wall. For this alternative, the container would thus be lifted onto the inclined surface above the fixed stop to be brought down into blocked contact therewith.

Other examples of variations is the use of a curved slope profile of the container support surface or the use of other appropriate releasable locking parts than those primarily mentioned herein for locking a tilted container in position. The shape of all relevant parts may be modified for specific applications and they may with minor modifications be used with any appropriate type of container configuration. It shall also be emphasized that although the invention has been described and illustrated with specific reference to an application in a vacuum operated waste collection system, the invention is in no way restricted to such applications. The basic principles of the invention may be applied to other waste collection and transport systems.

The present technology has been described in connection with an embodiment that is to be regarded as an illustrative example thereof. It will be understood by those skilled in the art that the present technology is not limited to the disclosed embodiments but is intended to cover various modifications and equivalent arrangements. The present technology likewise covers any feasible combination of features described and illustrated herein. The scope of the present technology is defined by the appended claims.

1. A method of compacting and managing waste (W), wherein waste is introduced into a generally box-shaped elongated waste container (3) through at least one waste inlet (5) thereof and is collected in the waste container (3) at a waste collection station (4), characterized by:
positioning the container with a generally rectangular bottom wall (3A) thereof on an inclined surface (7) of the waste collection station; thereby
tilting the container and its bottom wall relative to a base surface (G);
releasably and securely holding the container in the tilted position.

2. A method according to claim 1, characterized by positioning the at least one waste inlet (5) at a front end wall (3C) of the waste container (3), adjacent a top wall (3B) thereof, that is elevated in the tilted position of the container.

3. A method according to claim 1 or 2, characterized by providing a container handling frame (10) and extending said container handling frame along a major portion of the container bottom wall (3A) and at least partially along a rear container end wall (3D).

4. A method according to any of claims 1-3, characterized by removing the tilted container for haulage and emptying by sliding it down the inclined surface (7) and by preferably facilitating such sliding by providing support wheels (11) on a bottom part (10A) of the handling frame (10).

5. A method according to any of claims 1-4, characterized by pushing up the container (3) into position on the inclined surface (7) such as by means of a haulage truck (20) used for switching containers, thereby also docking the container waste inlet (5) with a waste transport pipe (2) of a waste collection system (1).

6. A method according to any of claims 1-5, characterized by initiating sliding of the container (3) down the inclined surface (7) for switching containers by lifting and pulling, preferably by means of a haulage truck (20) hook-lift (21) used for switching containers (3), a towing-type eyelet (12) provided on an upright part (10B) of the handling frame (10) extending at least partially along the rear container end wall (3D), thereby releasing the container from the secure holding thereof.

7. A method according to claim 6, characterized by initiating removal of a loaded container (3) from the inclined surface (7) by lifting a lower end wall (3D) of the container (3) by the towing-type eyelet (12) thereby releasing engagement of a releasable latch (16) provided adjacent each of two side walls (3E, 3F) of the container with a respective lock bolt (17) secured to the corresponding container side wall.

8. A waste collection facility (13) of a waste collection station (4), including a generally box-shaped elongated waste container (3) having at least one waste inlet (5) for the introduction and collection of waste in the waste container (3), characterized by a ramp-like container support (6) having an inclined container support surface (7) and by cooperating connectable and releasable locking means (16, 17) provided to lock in position a tilted container being supported on the ramp-like container support and to release said container for removal, respectively.

9. A waste collection facility (13) according to claim 8, characterized by a container handling frame (10) being secured to and extending along a major portion of a container (3) bottom wall (3A) and at least partially along a rear container end wall (3D).

10. A waste collection facility (13) according to claim 8 or 9, characterized in that the cooperating connectable and releasable locking means (16, 17) include a lock bolt (17) attached to each of two container side walls (3E, 3F), a releasable latch (16) provided adjacent to each side of the ramp-like container support (6) for cooperation with a corresponding lock bolt of the container side walls.

11. A waste collection facility (13) according to claim 9 or 10, characterized by a towing-type eyelet (12) being secured to an upright part (10B) of the handling frame (10) extending at least partially along the rear container end wall (3D) for at least initiating/promoting sliding of the container (3) down the inclined surface (7) by lifting and pulling said towing-type eyelet, thereby disengaging the lock bolt (17) from the latch (16), preferably by means of a haulage truck (20) used for switching containers (3).

12. A waste collection facility (13) according to any of claims 9 to 11, characterized by support wheels (11) being provided on a bottom part (10A) of the container handling frame (10) for facilitating sliding of the container (3) up as well as down the inclined surface (7).

13. A waste collection facility (13) according to any of claims 10-12, characterized in that the latch (16) is rotatably supported on a pivot pin (18) for rotation in one direction allowing its free passage past the lock bolt (17) as the container (3) is pushed upwardly on the inclined container support surface (7) and is blocked from rotation in an opposite direction to lock the container in its tilted position on the inclined container support surface.

14. A waste collection facility (13) according to any of claims 8-13, characterized in that the inclined container support surface (7) of the ramp-like container support (6) is inclined at an angle (α) of approximately 20-90°, preferably 30°, relative to a ground surface (G).

15. A waste collection facility (13) according to any of claims 8-14, characterized in that the waste inlet (5) is equipped with a curved docking cone (5A) allowing secure docking with a waste collection system (1) waste transport pipe (2).
